(19) United States
(12) Patent Application Publication
(10) Pub. No.: US 2011/0272938 A1
(43) Pub. Date: Nov. 10, 2011

(54) FAST CONNECTING TUBE MODULE

(76) Inventor: Ming-Shuan Lin, Taichung Hsien (TW)

(21) Appl. No.: 12/773,250

(22) Filed: May 4, 2010

(51) Int. Cl. F16L 25/06

(52) U.S. Cl. 285/330

(57) ABSTRACT

A connecting tube module includes first and second tube members and a leakproofing member. The first tube member has an inner wall surface that is formed with a lock groove extending in a circumferential direction, and a slide groove extending parallel to a tube axis. The lock groove has an entrance end corresponding in location to the slide groove in a direction of the tube axis and a lock end opposite to the entrance end along the circumferential direction. The second tube member has an outer wall surface provided with a protruding block. The leakproofing member is disposed between the inner wall surface and the outer wall surface. When the second tube member is inserted into the first tube member, the protruding block slides along the slide groove into the entrance end and is disposed at the lock end upon relative rotation of the first and second tube members in the circumferential direction.

### BACKGROUND OF THE INVENTION

1. Field of the Invention

The invention relates to a tube connecting mechanism, more particularly to a fast connecting tube module.

2. Description of the Related Art

A conventional plastic faucet spout has the advantages of being lightweight and economical. However, since the spout is curvy and difficult for mold removal, current plastic faucet spouts are often broken into several separate components that need to be assembled together for use.

As shown in FIG. 1, a conventional faucet spout includes a first connecting tube 1, a second connecting tube 2 and a lock ring 3. The first connecting tube 1 has a flange 101, and a sleeve segment 102 connected to the flange 101. The second connecting tube 2 has an assembling segment 201 for insertion of the sleeve segment 102 of the first connecting tube 1 therein, and a shoulder 202 connected to the assembling segment 201. The lock ring 3 has a slit 301 resulting in a C-shaped cross-section, and two ribs 302 formed on an inner surface of the lock ring 3. When the sleeve segment 102 of the first connecting tube 1 is inserted into the assembling segment 201 of the second connecting tube 2, the lock ring 3 can be coupled to the assembled first and second connecting tubes 1, 2 by expanding the same through the slit 301. Once the ribs 302 of the lock ring 3 respectively abut against the flange 101 of the first connecting tube 1 and the shoulder 202 of the second connecting tube 2, assembly of the conventional faucet spout is completed.

The conventional faucet spout has the following disadvantages:

1. With the provision of the lock ring 3, the number of components for the conventional faucet spout is increased, the number of assembly steps is increased, and the cost is also increased.

2. The lock ring 3 may be irreversibly deformed during expansion through the slit 301, thereby adversely affecting assembly of the first and second connecting tubes 1, 2.

3. The lock ring 3 only prevents relative movement between the first and second connecting tubes 1, 2 in the axial direction, and does not lock the first and second connecting tubes 1, 2 in the circumferential direction. Therefore, relative rotation between the first and second connecting tubes 1, 2 is possible, resulting in inconvenience during use of the conventional faucet spout.

### SUMMARY OF THE INVENTION

Therefore, the object of the present invention is to provide a fast connecting tube module that is simple in structure, and that facilitates fast and stable assembly.

According to the present invention, there is provided a connecting tube module that includes a first tube member, a second tube member, and a leakproofing member.

The first tube member defines a first inner space, and has first and second end portions that are opposite to each other along a tube axis, and a first inner wall surface that defines the first inner space and that extends from the first end portion to the second end portion. The first inner wall surface is formed at the first end portion with a first lock groove that extends in a circumferential direction and a first slide groove that extends parallel to the tube axis and that is in spatial communication with the first lock groove. The first lock groove has an entrance end that corresponds in location to the first slide groove in a direction along the tube axis and a lock end that is opposite to the entrance end along the circumferential direction.

The second tube member defines a second inner space, and has third and fourth end portions that are opposite to each other along the tube axis, and second inner and outer wall surfaces that extend from the third end portion to the fourth end portion. The second inner wall surface defines the second inner space. The second outer wall surface is disposed external of the second inner space and is opposite to the second inner wall surface in radial directions. The third end portion is inserted into the first end portion of the first tube member. The second outer wall surface is provided at the third end portion with a first protruding block.

The leakproofing member is disposed between the first inner wall surface of the first tube member at the first end portion and the second outer wall surface of the second tube member at the third end portion, and between the first lock groove and the second end portion of the first tube member.

When the third end portion is inserted into the first end portion, the first protruding block slides along the first slide groove into the entrance end of the first lock groove, and is disposed at the lock end of the first lock groove upon relative rotation of the first and second tube members in the circumferential direction.

The advantage of the present invention lies in that the overall structure is simple, and thus low cost, and that the connecting tube module is stable when assembled.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional faucet spout;

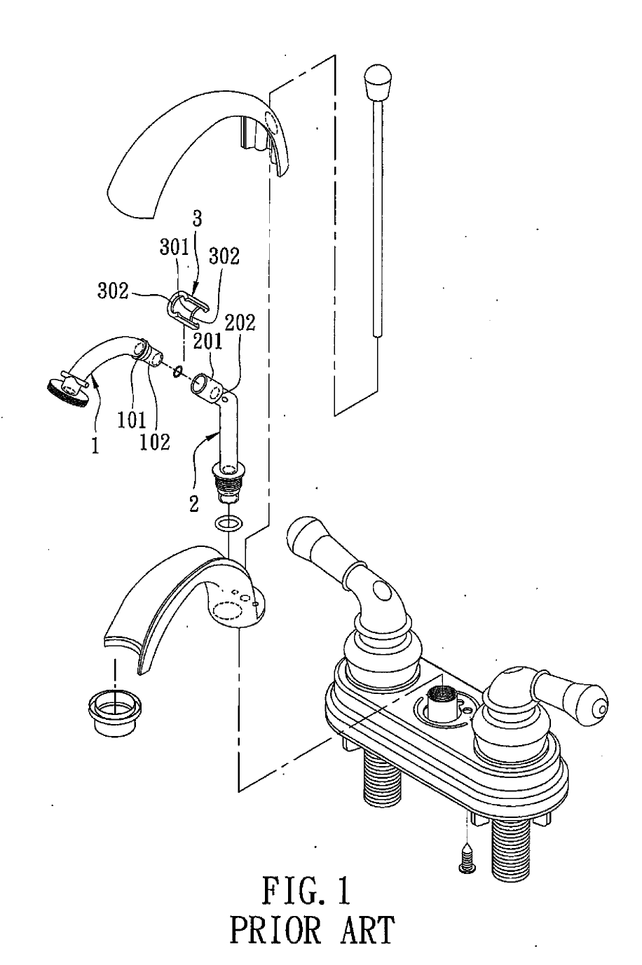

FIG. 2 is a fragmentary exploded perspective view of the preferred embodiment of a connecting tube module according to the present invention;

FIG. 3 is a fragmentary sectional view of the preferred embodiment, illustrating a first tube member and a second tube member as separate components;

FIG. 4 is a fragmentary sectional view of the preferred embodiment, illustrating assembly of the first and second tube members;

FIG. 5 is a sectional view of the first and second tube members taken along line V-V in FIG. 4, illustrating first protruding blocks of the second tube member disposed in entrance ends of first lock grooves in the first tube member;

FIG. 6 is a sectional view similar to FIG. 5, illustrating the first protruding blocks disposed in lock ends of the first lock grooves; and

FIG. 7 is a schematic sectional view of the connecting tube module applied to a spout according to the preferred embodiment.

### DETAILED DESCRIPTION OF THE PREFERRED EMBODIMENT

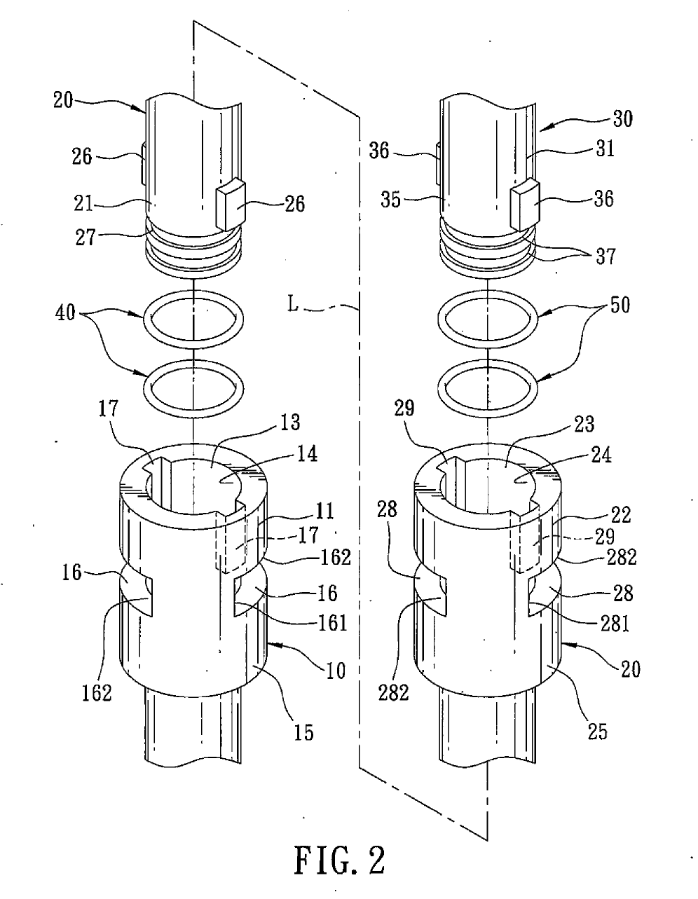

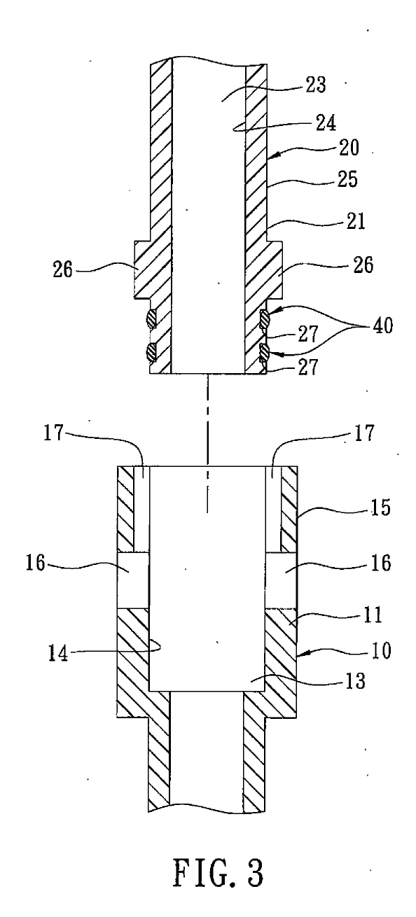

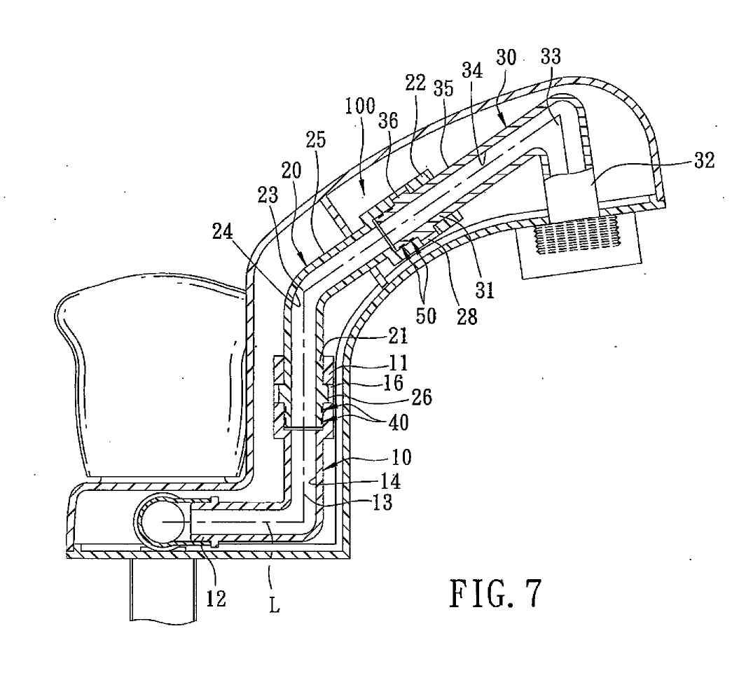

With reference to FIG. 2, FIG. 3 and FIG. 7, the preferred embodiment of a connecting tube module 100 of the present invention is illustrated to be applied to a spout of a plastic faucet. The connecting tube module 100 includes a first tube member 10, a second tube member 20, and a first leakproofing member 40.

The first tube member 10 defines a first inner space 13, and has first and second end portions 11, 12 that are opposite to each other along a tube axis (L), and a first inner wall surface 14 that defines the first inner space 13 and that extends from the first end portion 11 to the second end portion 12. The first inner wall surface 14 is formed at the first end portion 11 with a first lock groove 16 that extends in a circumferential direction and a first slide groove 17 that extends parallel to the tube axis (L) and that is in spatial communication with the first lock groove 16. The first lock groove 16 has an entrance end 161 that corresponds in location to the first slide groove 17 in a direction of the tube axis (L), and a lock end 162 that is opposite to the entrance end 161 along the circumferential direction. It should be noted herein that the tube axis (L) as disclosed herein refers to an axis of the assembled connecting tube module 100. In cases where the connecting tube module 100 is curved, as illustrated in FIG. 7, the tube axis (L) is also curved.

The second tube member 20 defines a second inner space 23, and has third and fourth end portions 21, 22 that are opposite to each other along the tube axis (L), and second inner and outer wall surfaces 24, 25 that extend from the third end portion 21 to the fourth end portion 22. The second inner wall surface 24 defines the second inner space 23. The second outer wall surface 25 is disposed external of the second inner space 23 and is opposite to the second inner wall surface 24 in radial directions. The third end portion 21 is inserted into the first end portion 11 of the first tube member 1. The second outer wall surface 25 is provided at the third end portion 21 with a first protruding block 26.

The first leakproofing member 40 is disposed between the first inner wall surface 14 of the first tube member 10 at the first end portion 11 and the second outer wall surface 25 of the second tube member 20 at the third end portion 21 and between the first lock groove 16 and the second end portion 12 of the first tube member 10.

When the third end portion 21 of the second tube member 20 is inserted into the first end portion 11 of the first tube member 10, the first protruding block 26 slides along the first slide groove 17 into the entrance end 161 of the first lock groove 16, and is disposed at the lock end 162 of the first lock groove 16 upon relative rotation of the first and second tube members 10, 20 in the circumferential direction.

In this embodiment, the first tube member 10 further has a first outer wall surface 15 that extends from the first end portion 11 to the second end portion 12, that is disposed external of the first inner space 13, and that is opposite to the first inner wall surface 14 in the radial directions. The first lock groove 16 extends through the first inner and outer wall surfaces 14, 15. The second outer wall surface 25 of the second tube member 20 is formed at the third end portion 21 with a first circumferential groove 27 for receiving the first leakproofing member 40 therein. It should be noted herein that the first circumferential groove 27 is disposed between the first protruding block 26 and an end of the third end portion 21 that is distal from the fourth end portion 22.

More particularly, the first tube member 10 is formed with two of the first slide grooves 17 that are diametrically disposed, and two of the first lock grooves 16 that are respectively in spatial communication with the first slide grooves 17. The second outer wall surface 25 of the second tube member 20 is provided with two of the first protruding blocks 26 that are diametrically disposed. It is noted herein that the entrance end 161 of only one of the first lock grooves 16 is visible in FIG. 2.

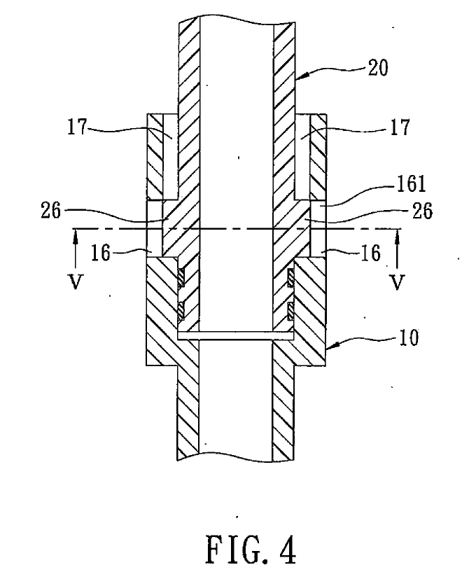

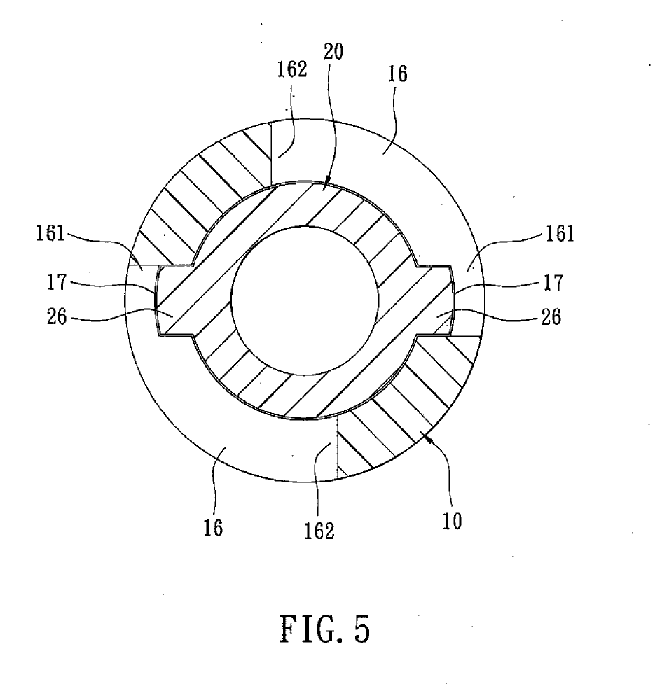

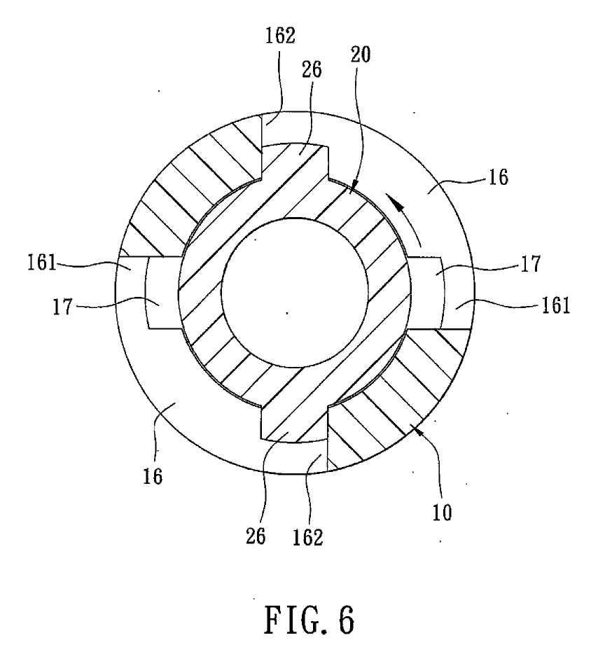

With reference to FIG. 3 and FIG. 4, to assemble the first and second tube members 10, 20, the first protruding blocks 26 are aligned with the first slide grooves 17 and the third end portion 21 is inserted into the first end portion 11, such that each of the first protruding blocks 26 slides along a corresponding one of the first slide grooves 17 into the entrance end 161 of a corresponding one of the first lock grooves 16, as illustrated in FIG. 5. Then, the first and second tube members 10, 20 are rotated relative to each other in the circumferential direction until each of the first protruding blocks 26 is disposed at the lock end 162 of the corresponding one of the first lock grooves 16, as illustrated in FIG. 6.

Moreover, the preferred embodiment includes two of the first leakproofing members 40, and the second outer wall surface 25 of the second tube member 20 is formed at the third end portion 21 with two of the first circumferential grooves 27 for respectively receiving the first leakproofing members 40 therein.

In this embodiment, the connecting tube module further includes a third tube member 30 and a second leakproofing member 50. The second inner wall surface 24 of the second tube member 20 is formed at the fourth end portion 22 with a second lock groove 28 that extends in the circumferential direction and a second slide groove 29 that extends parallel to the tube axis (L) and that is in spatial communication with the second lock groove 28. The second lock groove 28 has an entrance end 281 that corresponds in location to the second slide groove 29 in the direction of the tube axis (L) and a lock end 282 that is opposite to the entrance end 281 along the circumferential direction.

The third tube member 30 defines a third inner space 33, and has fifth and sixth end portions 31, 32 that are opposite to each other along the tube axis (L), and third inner and outer wall surfaces 34, 35 that extend from the fifth end portion 31 to the sixth end portion 32. The third inner wall surface 34 defines the third inner space 33. The third outer wall surface 35 is disposed external of the third inner space 33, and is opposite to the third inner wall surface 34 in the radial directions. The fifth end portion 31 of the third tube member 30 is inserted into the fourth end portion 22 of the second tube member 20. The third outer wall surface 35 is provided at the fifth end portion 31 with a second protruding block 36.

The second leakproofing member 50 is disposed between the second inner wall surface 24 of the second tube member 20 at the fourth end portion 22 and the third outer wall surface 35 of the third tube member 30 at the fifth end portion 31 and between the second lock groove 28 and the third end portion 21 of the second tube member 20.

When the fifth end portion 31 of the third tube member 30 is inserted into the fourth end portion 22 of the second tube member 20, the second protruding block 36 slides along the second slide groove 29 into the entrance end 281 of the second lock groove 28, and is disposed at the lock end 282 of the second lock groove 28 upon relative rotation of the second and third tube members 20, 30 in the circumferential direction.

In this embodiment, the third outer wall surface 35 of the third tube member 30 is formed at the fifth end portion 31 with a second circumferential groove 37 for receiving the second leakproofing member 50 therein. It should be noted herein that the second circumferential groove 37 is disposed between the second protruding block 26 and an end of the fifth end portion 31 that is distal from the sixth end portion 32.

More particularly, the second tube member 20 is formed with two of the second slide grooves 29 that are diametrically disposed, and two of the second lock grooves 28 that are respectively in spatial communication with the second slide grooves 29. The third outer wall surface 35 of the third tube member 30 is provided with two of the second protruding blocks 36 that are diametrically disposed.

When the fifth end portion 31 of the third tube member 30 is inserted into the fourth end portion 22 of the second tube member 20, each of the second protruding blocks 36 slides along a corresponding one of the second slide grooves 29 into the entrance end 281 of a corresponding one of the second lock grooves 28 (the entrance end 281 of only one of the second lock grooves 28 is visible in FIG. 2), and is disposed at the lock end 282 of the corresponding one of the second lock grooves 28 upon relative rotation of the second and third tube members 20, 30 in the circumferential direction. Since the manner of assembling the second and third tube members 20, 30 is identical to that of the first and second tube members 10, 20 as described above, further details of the same are omitted herein for the sake of brevity.

It should be noted herein that, as illustrated in FIG. 7, the second tube member 20 is curvy. However, for simplicity of illustration, the second tube member 20 is shown to be straight in FIG. 2.

In summary, the present invention has the following advantages:

1. With the provision of only the tube members 10, 20, 30 and the leakproofing members 40, 50, the connecting tube module 100 can be fully assembled, and the connecting tube module 100 can also be used for curvy applications. Not only is the number of components small, the assembly procedure is also simple, and the cost of the connecting tube module 100 is relatively low.

2. During assembly of the first and third end portions 11, 21 of the first and second tube members 10, 20, and the assembly of the fourth and fifth end portions 22, 31 of the second and third tube members 20, 30, no expansion or deformation of components would occur, while good coupling effects are achieved.

3. With the first and second protruding blocks 26, 36 respectively disposed in the lock ends 162, 282 of the lock grooves 16, 28, relative rotations between the first and second tube members 10, 20 and between the second and third tube members 20, 30 in the circumferential direction are prevented, such that it is convenient during use or during mounting of other peripheral components.

It should be noted herein that application of the connecting tube module 100 of the present invention is not limited to the spout illustrated in the preferred embodiment, and other tube applications are also viable.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A connecting tube module comprising:
a first tube member defining a first inner space, and having first and second end portions that are opposite to each other along a tube axis, and a first inner wall surface that defines said first inner space and that extends from said first end portion to said second end portion, said first inner wall surface being formed at said first end portion with a first lock groove that extends in a circumferential direction and a first slide groove that extends parallel to the tube axis and that is in spatial communication with said first lock groove, said first lock groove having an entrance end that corresponds in location to said first slide groove in a direction of the tube axis and a lock end that is opposite to said entrance end along the circumferential direction;
a second tube member defining a second inner space, and having third and fourth end portions that are opposite to each other along the tube axis, and second inner and outer wall surfaces that extend from said third end portion to said fourth end portion, said second inner wall surface defining said second inner space, said second outer wall surface being disposed external of said second inner space and being opposite to said second inner wall surface in radial directions, said third end portion being inserted into said first end portion of said first tube member, said second outer wall surface being provided at said third end portion with a first protruding block; and
a first leakproofing member disposed between said first inner wall surface of said first tube member at said first end portion and said second outer wall surface of said second tube member at said third end portion and between said first lock groove and said second end portion of said first tube member;
wherein when said third end portion is inserted into said first end portion, said first protruding block slides along said first slide groove into said entrance end of said first lock groove, and is disposed at said lock end of said first lock groove upon relative rotation of said first and second tube members in the circumferential direction.

2. The connecting tube module as claimed in claim 1, wherein said first tube member further has a first outer wall surface that extends from said first end portion to said second end portion, that is disposed external of said first inner space, and that is opposite to said first inner wall surface in the radial directions, said first lock groove extending through said first inner and outer wall surfaces.

3. The connecting tube module as claimed in claim 2, wherein said second outer wall surface of said second tube member is formed at said third end portion with a first circumferential groove for receiving said first leakproofing member therein, said first circumferential groove being disposed between said first protruding block and an end of said third end portion that is distal from said fourth end portion.

4. The connecting tube module as claimed in claim 3, wherein said first tube member is formed with two of said first slide grooves that are diametrically disposed, and two of said first lock grooves that are respectively in spatial communication with said first slide grooves, said second outer wall surface of said second tube member being provided with two of said first protruding blocks that are diametrically disposed.

5. The connecting tube module as claimed in claim 4, further comprising a third tube member and a second leakproofing member, said second inner wall surface of said second tube member being formed at said fourth end portion with a second lock groove that extends in the circumferential direction and a second slide groove that extends parallel to the tube axis and that is in spatial communication with said second lock groove, said second lock groove having an entrance end that corresponds in location to said second slide groove in the direction of the tube axis and a lock end that is opposite to said entrance end along the circumferential direction,
said third tube member defining a third inner space, and having fifth and sixth end portions that are opposite to each other along the tube axis, and third inner and outer wall surfaces that extend from said fifth end portion to said sixth end portion, said third inner wall surface defining said third inner space, said third outer wall surface being disposed external of said third inner space and being opposite to said third inner wall surface in the radial directions, said fifth end portion of said third tube member being inserted into said fourth end portion of said second tube member, said third outer wall surface being provided at said fifth end portion with a second protruding block,
said second leakproofing member being disposed between said second inner wall surface of said second tube member at said fourth end portion and said third outer wall surface of said third tube member at said fifth end portion and between said second lock groove and said third end portion of said second tube member;
wherein when said fifth end portion is inserted into said fourth end portion, said second protruding block slides along said second slide groove into said entrance end of said second lock groove, and is disposed at said lock end of said second lock groove upon relative rotation of said second and third tube members in the circumferential direction.

6. The connecting tube module as claimed in claim 5, wherein said third outer wall surface of said third tube member is formed at said fifth end portion with a second circumferential groove for receiving said second leakproofing member therein, said second circumferential groove being disposed between said second protruding block and an end of said fifth end portion that is distal from said sixth end portion.

7. The connecting tube module as claimed in claim 6, wherein said second tube member is formed with two of said second slide grooves that are diametrically disposed, and two of said second lock grooves that are respectively in spatial communication with said second slide grooves, said third outer wall surface of said third tube member being provided with two of said second protruding blocks that are diametrically disposed.
